(19) United States
(12) Patent Application Publication
(10) Pub. No.: US 2007/0230039 A1
(43) Pub. Date: Oct. 4, 2007

(54) Clamp ring and disc drive having the same

(75) Inventors: Yoshiaki Koizumi, Kawasaki (JP); Misao Inoke, Kawasaki (JP); Masaya Suwa, Kawasaki (JP); Rikako Shinomiya, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/452,961

(22) Filed: Jun. 15, 2006

(30) Foreign Application Priority Data
Mar. 29, 2006 (JP) 2006-089716

(51) Int. Cl. G11B 17/02

(52) U.S. Cl. 360/99.12

(57) ABSTRACT

A clamp ring that clamps a disc onto a spindle motor that rotates the disc includes an annular disc shaped body fixed onto a hub that rotates with a shaft of the spindle motor, the body arranging plural screw holes in a circumferential direction of the body, a screw that fixes the body onto the hub being inserted into each screw hole, wherein the body arranges plural stress relaxation holes between the plural screw holes so that each stress relaxation hole and each screw hole alternate in the circumferential direction of the body, each stress relaxation hole mitigating a deformation of the body in fixing the body onto the hub with the screw, a diameter of the stress relaxation hole being equal to or greater than a diameter of the screw hole in a surface of the body from which the screw is inserted into the body.

This application claims the right of a foreign priority based on Japanese Patent Application No. 2006-089716, filed on Mar. 29, 2006, which is hereby incorporated by reference herein in its entirety as if fully set forth herein.

### BACKGROUND OF THE INVENTION

The present invention relates generally to a recorder, and more particularly to a clamping unit for clamping a disc or discs as a recording medium in a disc drive. The present invention is suitable, for example, for a clamp ring that fixes a disc or discs onto a spindle hub in a hard disc drive (“HDD”).

Along with the recent spreads of the Internet etc., a demand for fast recording of a large amount of information is growing. A magnetic disc drive, such as an HDD, is required for a larger capacity and improved response. For the larger capacity, the HDD narrows a track pitch on the disc, and increases the number of installed discs. For the improved response, use of a faster spindle motor is promoted.

Plural discs are stacked around a hub that is fixed around a rotating shaft of the spindle motor, and they are capped by a clamp ring. These discs are clamped by screwing the clamp ring onto the hub. The number of screws can be one, three, four (Japanese Patent Application, Publication No. 2001-331995), six, etc. The clamp ring and the screw(s) rotate with the disc(s).

A recent high-density disc needs highly precise head positioning. For this purpose, it is necessary to restrain vibrations applied to and deformations of the disc. A fastening force in screwing the clamp ring onto the hub is one factor of the vibrations and deformations of the disc. Each screw applies the load around a screw hole in the clamp ring, and generates undulation in the circumferential direction. This undulation becomes non-negligible as more precise head positioning is required. If the screw's fastening force is made weaker, the undulation would reduce but instead insufficient disc clamping would make the HDD fragile to external impacts and its spindle motor's vibrations.

### BRIEF SUMMARY OF THE INVENTION

Accordingly, it is an exemplary object of the present invention to provide a clamp ring and a disc drive having the same, which reduces undulation in attaching the clamp ring to a hub.

A clamp ring according to one aspect of the present invention that clamps a disc onto a spindle motor that rotates the disc includes an annular disc shaped body fixed onto a hub that rotates with a shaft of the spindle motor, the body arranging plural screw holes in a circumferential direction of the body, a screw that fixes the body onto the hub being inserted into each screw hole, wherein the body arranges plural stress relaxation holes between the plural screw holes so that each stress relaxation hole and each screw hole alternate in the circumferential direction of the body, each stress relaxation hole mitigating a deformation of the body in fixing the body onto the hub with the screw, a diameter of the stress relaxation hole being equal to or greater than a diameter of the screw hole in a surface of the body from which the screw is inserted into the body. In comparison with the diameter of the stress relaxation hole that is 43% as large as the diameter of the screw hole, the stress peak value applied to the disc can be reduced down to 50% or greater as a result of setting the diameter of the stress relaxation hole is equal to or greater than the diameter of the screw hole. The diameter of the stress relaxation hole is preferably 1.11 times or 1.14 times or greater as large as the diameter of the screw hole in the surface of the body. By setting the diameter 1.11 times or greater, the sixth order component or sixth harmonics of the undulation can be reduced in comparison with the diameter of the stress relaxation hole that is 43% as large as the diameter of the screw hole. By setting the diameter 1.14 times or greater, the stress peak value applied to the disc can be reduced in comparison with the diameter of the stress relaxation hole that is 43% as large as the diameter of the screw hole. For example, the body has six screw holes and six stress relaxation holes, and the diameter of the screw hole is 3.5 mm. The screw applies the load of 40 kg or greater.

A circle that passes centers of the plural stress relaxation holes may be greater than a circle that passes centers of the plural screw holes. A position of the stress relaxation hole is more influential than a diameter and thickness of the stress relaxation hole, and the undulation reduction effect increases as the stress relaxation hole is located to the outside. In addition, this configuration gives an additional effect: When the centers of both stress relaxation holes and screw holes are arranged on the same circle, a wall becomes thin between each stress relaxation hole and each screw hole as the diameter of the stress relaxation hole increases and thus working becomes difficult. When the wall is torn down, burrs and dust or fine particles occur. The fine particles when dropping on the disc causes a collision between the head and the disc, resultant damages of at least one of them, and information recording and reproducing errors. When the circle that passes the centers of the screw holes shifts from the circle that passes the centers of the stress relaxation holes, the arrangement of the stress relaxation holes compromises with a sufficiently thick wall between the screw hole and the stress relaxation hole. Therefore, workability improves.

The clamp ring preferably further includes an annular disc pressure portion that is provided onto the body and presses the disc, the stress relaxation holes being located inside the disc pressure portion.

A clamp ring according to another aspect of the present invention that clamps a disc onto a spindle motor that rotates the disc includes an annular disc shaped body fixed onto a hub that rotates with a shaft of the spindle motor, the body arranging plural screw holes in a circumferential direction of the body, a screw that fixes the body onto the hub being inserted into each screw hole, wherein the body arranges plural stress relaxation holes between the plural screw holes so that each stress relaxation hole and each screw hole alternate in the circumferential direction of the body, each stress relaxation hole mitigating a deformation of the body in fixing the body onto the hub with the screw, an area of the stress relaxation holes being equal to or greater than an area of the screw holes in a surface of the body from which the screw is inserted into the body. This clamp ring exhibits the effects similar to those of the above clamp ring. In that case, an area of each stress relaxation hole is greater than an area of each screw hole or a gross area of the stress relaxation holes is greater than a gross area of the screw holes.

A disc drive that includes one of the above clamp rings also constitutes one aspect of the present invention.

Other objects and further features of the present invention will become readily apparent from the following description of the preferred embodiments with reference to accompanying drawings.

### BRIEF DESCRIPTION OF THE DRAWINGS

FIG. 1 is an internal structure of a hard disc drive (“HDD”) according to one embodiment of the present invention.

FIG. 2 is an enlarged perspective view of a magnetic head part in the HDD shown in FIG. 1.

FIG. 3 is a partially sectional and perspective view near a spindle motor shown in FIG. 1.

FIG. 4A is a perspective view of a clamp ring viewed from the upper side according to this embodiment. FIG. 4B is a perspective view of a clamp ring viewed from the lower side according to this embodiment.

FIG. 5 is a schematic sectional view of a pre-screwed clamp ring.

FIG. 6 is a graph for explaining effects of the clamp ring according to this embodiment.

FIG. 7A is a perspective view of a clamp ring viewed from the upper side which has small stress relaxation holes. FIG. 7B is a perspective view of a clamp ring viewed from the upper side which has large stress relaxation holes. FIG. 7C is a perspective view of a clamp ring that has screw holes but no stress relaxation hole.

FIG. 8 is a graph that investigates changes of the undulation sixth order component or sixth harmonics applied to the clamp ring by changing a stress relaxation hole condition and a fastening condition.

FIG. 9A is a schematic perspective view of an analysis model for explaining a relationship among the diameter, the center position, the thickness of the stress relaxation hole, and the undulation reduction effect. FIG. 9B is a graph as an analysis result.

FIG. 10 is a block diagram of a control system of a HDD shown in FIG. 1.

### DETAILED DESCRIPTION OF THE PREFERRED EMBODIMENTS

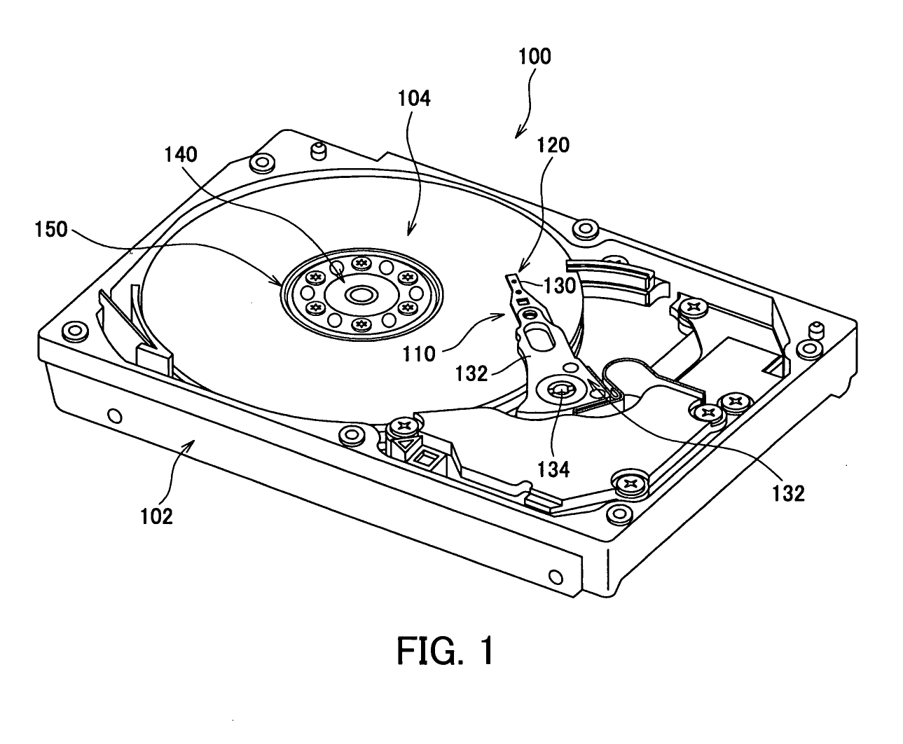

Referring now to the accompanying drawings, a description will be given of a HDD 100 according to one embodiment of the present invention. The HDD 100 includes, as shown in FIG. 1, one or more magnetic discs 104 each serving as a recording medium, a head stack assembly (“HSA”) 110, a spindle motor 140, and clamp ring 150 in a housing 102. Here, FIG. 1 is a schematic plane view of the internal structure of the HDD 100.

The housing 102 is made, for example, of aluminum die cast base and stainless steel, and has a rectangular parallelepiped shape to which a cover (not shown) that seals the internal space is jointed. The magnetic disc 104 of this embodiment has a high surface recording density, such as 100 Gb/in² or greater. The magnetic disc 104 is mounted on a spindle of the spindle motor 140 through its center hole.

The HSA 110 includes a magnetic head part 120, a suspension 130, and a carriage 132.

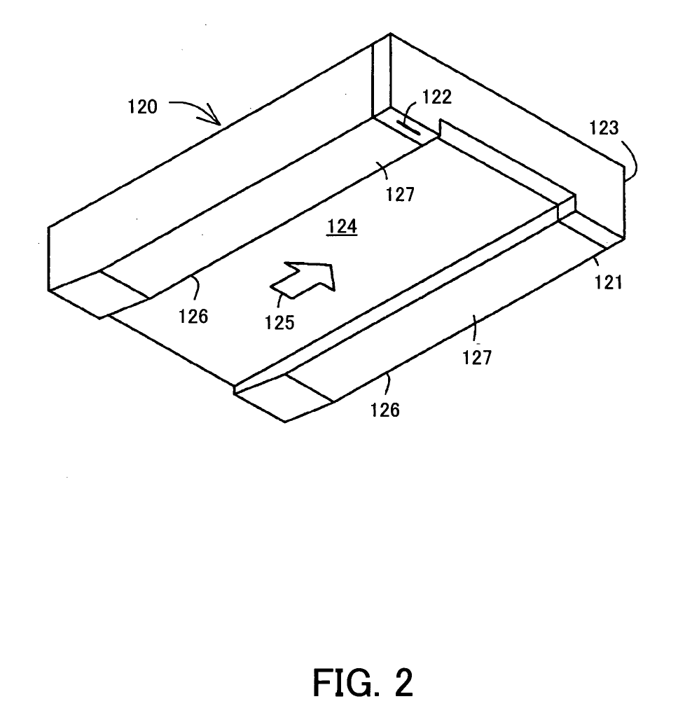

The magnetic head 120 includes, as shown in FIG. 2, an approximately rectangular parallelepiped, Al₂O₃—TiC (Altic) slider 121, and an Al₂O₃ (alumna) head device built-in film 123 that is jointed with an air outflow end of the slider 121 and has a reading/recording head 122. Here, FIG. 2 is an enlarged perspective view of the magnetic head part 120. The slider 121 and the head device built-in film 123 define a medium opposing surface to the magnetic disc 104, i.e., a floating surface 124. The floating surface 124 receives an airflow 125 that occurs with rotations of the magnetic disc 104.

A pair of rails 126 extend on the floating surface 124 from the air inflow end to the air outflow end. A top surface of each rail 126 defines a so-called air-bearing surface (“ABS”) 127. The ABS 127 generates a lifting force due to actions of the airflow 125. The head 122 embedded into the head device built-in film 123 exposes from the ABS 127. The floating system of the magnetic head part 120 is not limited to this mode, and may use known dynamic and static pressure lubricating systems, piezoelectric control system, and other floating systems.

The head 122 is an MR inductive composite head that includes an inductive head device that writes binary information in the magnetic disc 104 utilizing the magnetic field generated by a conductive coil pattern (not shown), and a magnetoresistive (“MR”) head that reads the binary information based on the resistance that varies in accordance with the magnetic field from the magnetic disc 104. A type of the MR head device is not limited, and may use a giant magnetoresistive (“GMR”), a CIP-GMR (“GMR”) that utilizes a current in plane (“CIP”), a CPP-GMR that utilizes a perpendicular to plane (“CPP”), a tunneling magnetoresistive (“TMR”), an anisotropic magnetoresistive (“AMR”), etc.

The suspension 130 serves to support the magnetic head part 120 and to apply an elastic force to the magnetic head part 120 toward the magnetic disc 104, and is, for example, a stainless-steel Watlas type suspension. This type of suspension has a flexure (also referred to as a gimbal spring or another name) which cantilevers the magnetic head part 120, and a load beam (also referred to as a load arm or another name) which is connected to the base plate. The suspension 130 also supports a wiring part that is connected to the magnetic head part 120 via a lead etc. Via this lead, the sense current flows and read/write information are transmitted between the head 122 and the wiring part.

The carriage 132 swings around a support shaft 134 by a voice coil motor (not shown). The carriage 132 is also referred to as an “actuator,” an “E-block” due to its E-shaped section or “actuator (“AC”) block.” A support portion of the carriage is referred to as an “arm,” an aluminum rigid body that can rotate or swing around the support shaft 134. The flexible printed circuit board (“FPC”) provides the wiring part with a control signal, a signal to be recorded in the disc 104, and the power, and receives a signal reproduced from the disc 104.

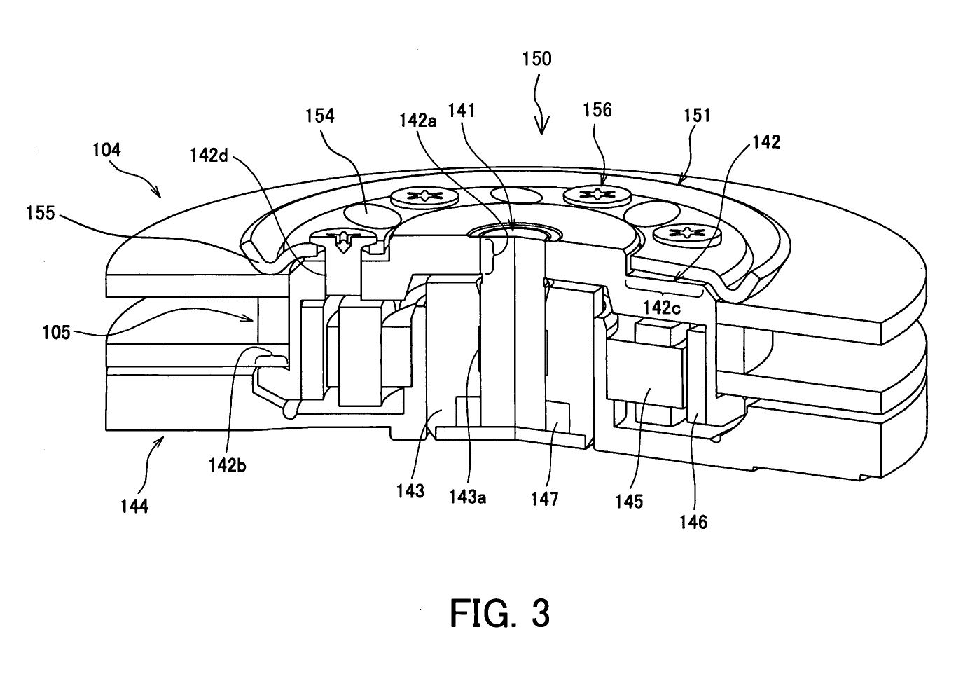

The spindle motor 140 rotates the magnetic disc 104 at such a high speed as 10,000 rpm, and has, as shown in FIG. 3, a shaft 141, a (spindle) hub 142, a sleeve 143, a bracket (base) 144, a core 145, and a magnet 146, an annular thrust plate 147, radial bearing (not shown), and lubricant oil (fluid) (not shown). In this embodiment, a yoke serves as the hub 142. The hub 142 and shaft 141 or the shaft 141 and the thrust plate 147 may be an integrated member. Here, FIG. 3 is a partially sectional and perspective view of the spindle motor 140.

The shaft 141 rotates with the disc 104 and the hub 142.

The hub 142 is fixed onto the shaft 141 at its top 142a, and supports the disc 104 on its flange 142b. The hub 142 has an annular attachment surface 142c to which a clamp ring 150's body 151 is attached. One or more (six in this embodiment) screw holes 142d are formed in the attachment surface 142c. While this embodiment provides six concentric screw holes 142d that are at regular intervals and apart from the center of the shaft 141 by the same distance, the present invention does not limit the number of screw holes 142d to six. A screw 156 is inserted into each screw hole 142d.

The sleeve 143 is a member that allows the shaft 141 to be mounted rotatably. The sleeve 143 is fixed in the housing 102. While the shaft 141 rotates, the sleeve 143 does not rotate and forms a fixture part with the bracket 144. The sleeve 143 has a groove or aperture into which the lubricant oil is introduced. In the sleeve 142, a groove or aperture is formed to introduce the lubricant oil. As the shaft 141 rotates, the lubricant oil generates the dynamic pressure (fluid pressure) along the groove.

The bracket (base) 144 is fixed onto the housing 102 around the sleeve 143, and supports the core (coil) 145, the magnet 146, and the yoke (not shown). The current flows through the core 145, and the core 145, the magnet 146 and the yoke that serves as the hub constitute a magnetic circuit. The magnetic circuit faces a voice coil motor of a carriage, and is used to swing a head. The thrust plate 147 is arranged at a lower central part of the sleeve 143, and forms the thrust bearing. The radial bearing (not shown) is a dynamic pressure bearing that supports the shaft 141 in a non-contact manner via the lubricant oil. There are two or more radial bearings along the longitudinal direction of the shaft 141, and each radial bearing extends around the shaft 141. The radial bearing supports the load in the radial direction of the shaft 141.

The clamp ring 150 serves to clamp the discs 104 and spacer 105 onto the spindle motor 140. The spacer 105 maintains an interval between discs 104.

The clamp ring 150 includes an annular disc shaped body 151. The body 151 is fixed onto the hub 142 by the screws 156, and includes a top surface 152, plural (six in this embodiment) screw holes 153, plural (six in this embodiment) stress relaxation holes 154, and a disc pressure portion 155.

The screws 156 that fix the body 151 onto the hub 142 are inserted into the six screw holes 153, and are arranged at regular intervals of 60° in the circumferential direction of the body 151. Although FIGS. 1 and 3 exaggerate the screw heads of the screws 156 as located outside or projecting from the top surface 152 of the body 151, step-shaped support parts 153a are formed in the screw holes 153 and the screw part of the screw 156 is inserted into a perforation hole 153b of the screw hole 153. In this embodiment, the screw head of the screw 156 is placed on the support part 153a in the screw hole 153, maintaining the top surface 152 approximately flat. Of course, this is merely for illustrative purposes only and the present invention does not prevent the screw hole 153 from being used as a perforation hole that has no support part 153a and the screw head of the screw 156 from being located outside or projecting from the top surface 152 of the body 151.

The six stress relaxation holes 154 are arranged at regular intervals of 60° between the screw holes 153 so that each stress relaxation hole 154 and each screw hole 153 alternate in the circumferential direction of the body 151. The stress relaxation holes 154 relax the deformation of the body 151 when the screws 156 fix the body 151 onto the hub 142. A line (not shown) that connects the center of the body 151 to the centers of the stress relaxation hole 154 shifts, by 30°, from a line (not shown) that connects the center of the body 151 to the center of the adjacent screw hole 153. The lines (not shown) that connect the center of the body 151 to the centers of the respective stress relaxation holes 154 and to the centers of the respective screw holes 153 spread at regular intervals of 30° in radial directions.

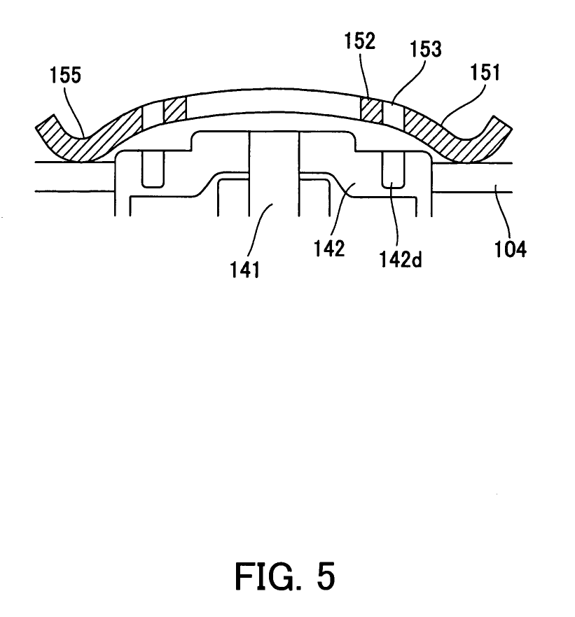

In this embodiment, the screw holes 153 and the stress relaxation holes 154 are perforation holes that extend in approximately parallel to the shaft 141 after the body 151 is attached to the hub 142. The phrase “after the body 151 is attached to the hub 142” means that the pre-attached body 151 may have such a bowl shape with a convex upward as shown in FIG. 5 in an orientation to be fixed onto the disc 104 and the hub 142 by the screws 156 that the inner side of the body 151 is distant from the top surface of the hub 142 than the outer side of the body 151. Here, FIG. 5 is a schematic sectional view that exaggerates the pre-screwed body 151. This inclination is formed along the entire perimeter or circumference of the body 151, providing the disc pressure portion 155 with an elastic force, and securing the weight against the disc 104. Thus, slight deformations of the body 151 by the screws 156 are expected. In that case, however, the vicinities of the screw holes 154 tend to undulate in the circumferential direction under the loads of the screws 156. When six screws 153 are used, six undulations are likely to appear in the circumferential direction of the body 151. These undulations are transferred to the disc 104 via the disc pressure portion 155. The stress relaxation holes 154 are members that intend to reduce these undulations.

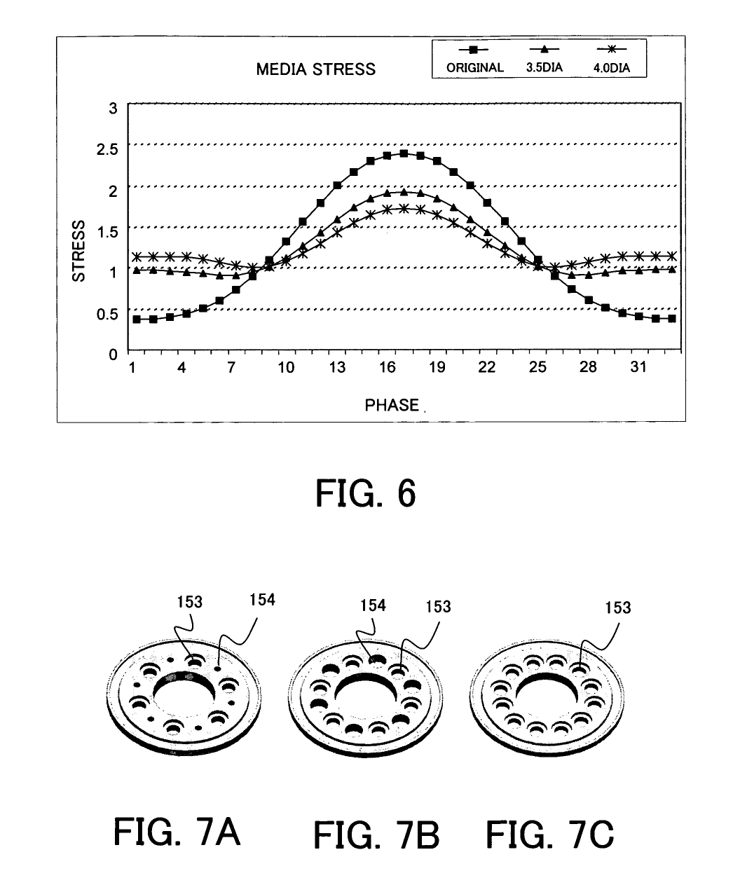

In the surface of the body 151 from which the screws 156 are inserted into the body 151 or the top surface 152 after the attachment, a diameter of each stress relaxation hole 154 is set greater than, preferably, is set 1.11 or 1.14 times or greater as large as a diameter of each screw hole 154.

Where the diameter of the screw hole 153 in the top surface 152 is set to 3.5 mm, maximum stress values (or peak stress values) applied to the medium or the disc 104 are investigated while the diameter of the stress relaxation holes 154 is varied to 1.5 mm, 3.5 mm, and 4.0 mm. FIG. 6 shows the result. FIG. 6 is a graph for explaining an effect of the clamp ring 150 of this embodiment, where the ordinate axis denotes the stress applied to the disc 104, and the abscissa axis denotes the phase.

In FIG. 6, a square graph correspond to the diameter of the stress relaxation hole 154 of 1.5 mm, a triangle graph correspond to the diameter of the stress relaxation hole 154 of 3.5 mm, and an asterisk graph correspond to the diameter of the stress relaxation hole 154 of 4.0 mm. As understood from FIG. 6, in comparison with the peak stress corresponding to the diameter of the stress relaxation hole 154 of 1.5 mm (which is about 43% as large as the diameter of the screw hole 153), the peak stress corresponding to the diameter of the stress relaxation hole 154 of 3.5 mm reduces by 50% and the peak stress corresponding to the diameter of the stress relaxation hole 154 of 4.0 mm reduces by 64%. The above “1.14 times” is derived from a ratio of 4.0 mm/3.5 mm=1.14.

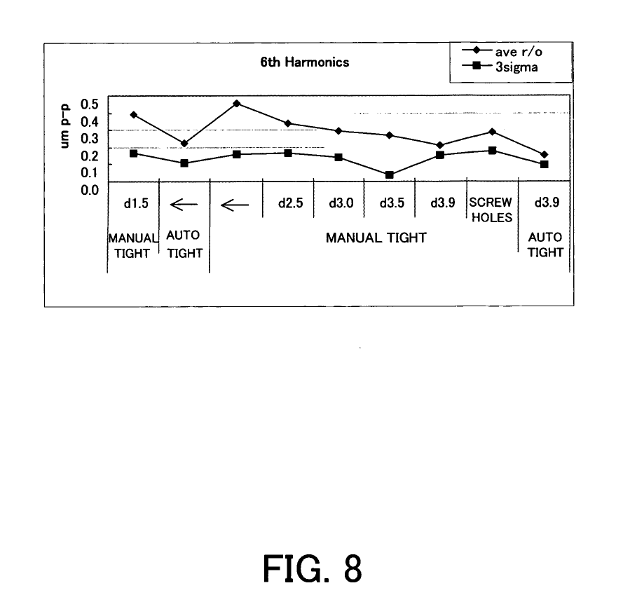

Next, where the diameter of the screw hole 153 is set to 3.5 mm in the top surface 152, undulation sextic (or sixth order) component or sixth harmonics variations are investigated while the diameter of the stress relaxation holes 154 is varied to 1.5 mm, 2.5 mm, 3.0 mm, 3.5 mm, and 3.9 mm, and with respect to the twelve screw holes 153 with no stress relaxation holes 154. FIG. 8 shows a result. FIG. 7A is a perspective view of the clamp ring viewed from the upper side, which sets the diameter of the stress relaxation hole 154 to 1.5 mm. FIG. 7B is a perspective view of the clamp ring viewed from the upper side, which sets the diameter of the stress relaxation hole 154 to 3.9 mm. FIG. 7C is a perspective view of the clamp ring viewed from the upper side, which arranges twelve screw holes 153 with no stress relaxation holes. FIG. 8 is a graph where the ordinate axis denotes a variation, the abscissa axis denotes a type of the stress relaxation hole or all screw holes and the fastening method, such as manual fastening and automatic fastening by a fastening machine. In FIG. 8, the rhombus graph corresponds to an average value of the sixth harmonics, and the square graph corresponds to 3σ (σ is standard deviation) component.

As understood from FIG. 8, in comparison with the diameter of the stress relaxation hole 154 of 1.5 mm (which is about 43% of the diameter of the screw hole 153), the average value of the manual fastening is reduced down to about 32% for the diameter of the stress relaxation hole 154 of d3.5 mm, and down to about 46% for the diameter of the stress relaxation hole 154 of d3.9 mm. An example that provides the twelve screw holes 153 and no stress relaxation holes 154 has a similar effect (about 27%) to the diameter of the stress relaxation hole 154 of d3.0 mm. When an improvement of 30% or greater is considered outstanding, it is preferable to provide the stress relaxation hole 154 and set its diameter to d3.5 mm or greater (i.e., equal to or greater than the screw hole's diameter). The average value of the automatic fastening is reduced down to about 32% with the diameter of the stress relaxation hole 154 of d3.9 mm. The above “1.11 times” is derived from a ratio of 3.9 mm/3.5 mm=1.11.

While this embodiment addresses both the peak stress value shown in FIG. 6 and the average value of the sixth order component shown in FIG. 8, other order components and the fastening method (manual or automatic) may be addressed, and the diameter of the stress relaxation hole may be adjusted based on the addressed parameter.

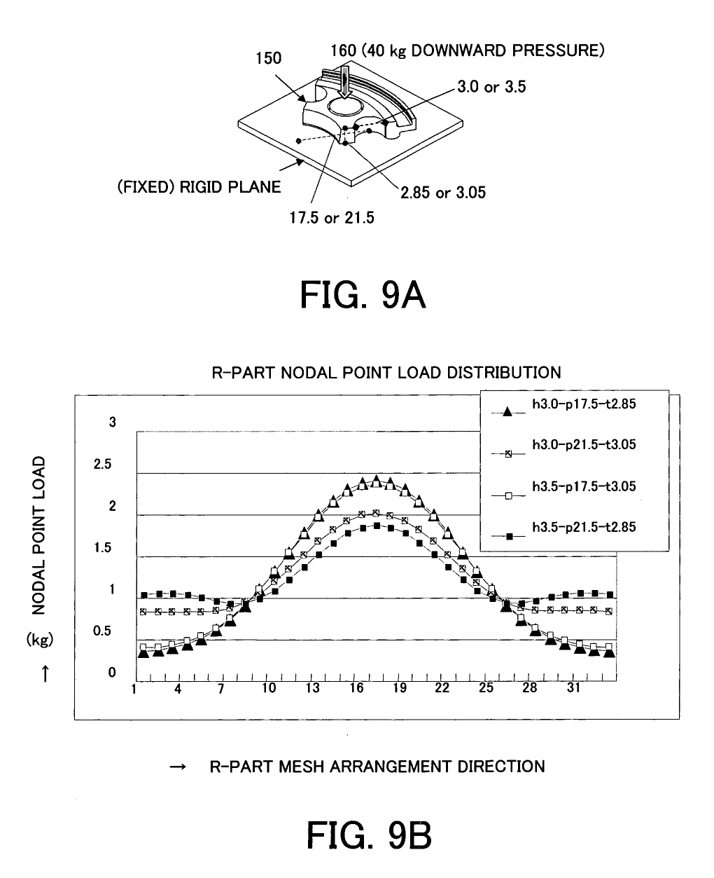

FIG. 9B is a graph that changes a diameter h, a center position p, and a thickness t of the stress relaxation hole 154 where the ordinate axis denotes the load applied to the disc, and the abscissa axis denotes the phase. Assume that each screw 156 applies the load of 40 kg, as shown in FIG. 9A. The diameter of the screw hole 153 is 3.0 mm. Here, FIG. 9A is a schematic perspective view of an analysis model for explaining a relationship among the diameter, the center position, and the thickness of the stress relaxation hole, the undulation reduction effect. FIG. 9B is a graph as an analysis result. In FIG. 9A, the Young's moduli of the materials of the clamp ring 150 and the screw 156 are 7,305 and 20,102 (kgf/mm²), respectively, and their Poisson's ratios are 0.345 and 0.29, respectively.

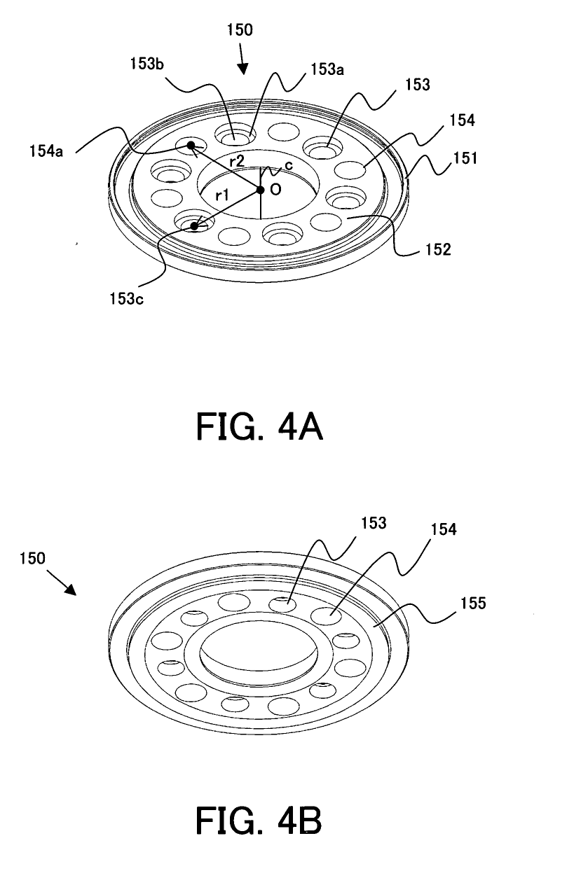

In FIG. 9B, a graph of a first stress relaxation hole 154 (h3.0-p17.5-t2.85) represents the diameter of 3.0 mm, a distance of 17.5 mm between the center of the body 151 and the center of each stress relaxation hole 154, and the thickness of 2.85 mm. Similarly, a graph of a second stress relaxation hole 154 (h3.0-p21.5-t3.05) represents the diameter of 3.0 mm, a distance of 21.5 mm between the center of the body 151 and the center of each stress relaxation hole 154, and the thickness of 3.05 mm. The most striking graph is a fourth stress relaxation hole 154 (h3.5-p21.5-t2.85), and the second stress relaxation hole 154 is the second place. It is understood from this result that the position of the stress relaxation hole 154 is a more influential parameter than the diameter and the thickness of the stress relaxation hole 154, and as the stress relaxation hole 154 is located to the outside the undulation reduction effect improves. Thus, this embodiment sets a diameter r2 of a circle that passes centers 154a of the stress relaxation holes 154 greater than a diameter r1 of a circle that passes centers 153c of the screw holes 153 of the in FIG. 4A. In FIG. 4A, O is a nodal point between the center axis C of the body 151 and the top surface 152 after attachment. This embodiment regards the top surface 152 as a plane after it is attached.

An additional effect is given when the stress relaxation holes 154 are arranged outside the screw holes 153. When the centers 153c and 154a of both holes are arranged on the same circle, a wall becomes thin between the stress relaxation hole 154 and the screw hole 153 as the diameter of the stress relaxation hole 154 increases and thus workability becomes difficult. When the wall is torn down, burrs and dust or fine particles occur. The fine particles when dropping on the disc 104 causes a collision between the head 122 and the disc 104, resultant damages of at least one of them, and information recording and reproducing errors. When the circle that passes the centers 153c of the screw holes 153 shifts from the circle that passes the centers 154a of the stress relaxation holes 154, the arrangement of the stress relaxation holes 154 compromises a sufficiently thick wall between the screw hole 153 and the stress relaxation hole 154. Therefore, the workability improves.

In this embodiment, the area of the stress relaxation holes 154 is equal to or greater than the area of the screw holes 154 in the top surface 152. The area of each stress relaxation hole 154 may be greater than the area of each screw hole 153, or the gross area of the stress relaxation holes 154 may be greater than the gross area of the screw holes 153. In the comparison of the gross area, the shape of the stress relaxation hole 154 may not be a perfect circle in the top surface 152 after attachment or the stress relaxation hole 152 may be divided although the divided parts should be symmetrically arranged for effectuate the undulation reduction.

The disc pressure portion 155 is an annular member that compresses the disc 104, which is provided at the bottom perimeter of the body 150. The stress relaxation hole 154 is provided inside the disc pressure portion 155.

The screws 156 fix the body onto the hub 142. When the screw 156 is fastened into the hub 142, it creates a clamping force that fixes the disc 104 onto the hub 142. The clamping force is transmitted to the pressure portion 155 when the seating face of the screw 156 presses the perimeter of the screw hole 153. The clamping force prevents the external force from shifting or vibrating the disc 104, but a deformation amount of the disc 104 caused by the claming force should be minimized so as to maintain the head positioning precision.

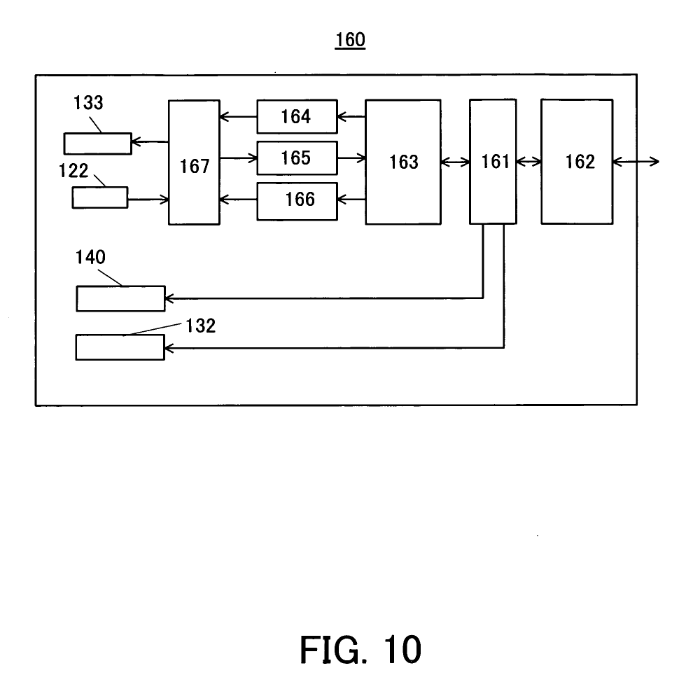

FIG. 10 shows a control block diagram of a control system 160 in the HDD 100. The control system 160 is a control illustration in which the head 122 has an inductive head and an MR head. The control system 160, which can be implemented as a control board in the HDD 100, includes a controller 161, an interface 162, a hard disc controller (referred to as “HDC” hereinafter) 163, a write modulator 164, a read demodulator 165, a sense-current controller 166, and a head IC 167. Of course, they are not necessarily integrated into one unit; for example, only the head IC 167 is connected to the carriage 132.

The controller 161 covers any processor such as a CPU and MPU irrespective of its name, and controls each part in the control system 160. The interface 162 connects the HDD 100 to an external apparatus, such as a personal computer (“PC” hereinafter) as a host. The HDC 163 sends to the controller 161 data that has been demodulated by the read demodulator 165, sends data to the write modulator 164, and sends to the sense-current controller 166 a current value as set by the controller 161. Although FIG. 10 shows that the controller 161 provides servo control over the spindle motor 140 and (a motor in) the carriage 132, the HDC 163 may serve as such servo control.

The write modulator 164 modulates data and supplies data to the head IC 162, which data has been supplied, for example, from the host through the interface 162 and is to be written down onto the disc 104 by the inductive head. The read demodulator 165 demodulates data into an original signal by sampling data read from the disc 104 by the MR head device. The write modulator 164 and read demodulator 165 may be recognized as one integrated signal processing part. The head IC 167 serves as a preamplifier. Each part may apply any structure known in the art, and a detailed description thereof will be omitted.

In operation of the HDD 100, the controller 161 drives the spindle motor 140 and rotates the disc 104. As discussed above, the clamp ring 150 reduces or eliminates the undulation or deformation of the body 151, and maintains the rotating precision of the disc 104 high. The clamping force applied by the body 151 prevents an offset of the disc 104 from the external impact, while maintaining a deformation amount of the disc 104. As a result, this embodiment provides a high head positioning precision.

The airflow associated with the rotation of the disc 104 is introduced between the disc 104 and slider 121, forming a minute air film and thus generating the lifting force that enables the slider 121 to float over the disc surface. The suspension 130 applies an elastic compression force to the slider 121 in a direction opposing to the lifting force of the slider 121. The balance between the lifting force and the elastic force spaces the magnetic head part 120 from the disc 104 by a constant distance. The controller 161 then controls the carriage 132 and rotates the carriage 132 around the support shaft 134 for head 122's seek for a target track on the disc 104.

In writing, the controller 161 receives data from the host (not shown) such as a PC through the interface 162, selects the inductive head device, and sends data to the write modulator 164 through the HDC 163. In response, the write modulator 164 modulates the data, and sends the modulated data to the head IC 167. The head IC 167 amplifies the modulated data, and then supplies the data as write current to the inductive head device. Thereby, the inductive head device writes down the data onto the target track.

In reading, the controller 161 selects the MR head device, and sends the predetermined sense current to the sense-current controller 166 through the HDC 163. In response, the sense-current controller 166 supplies the sense current to the MR head device through the head IC 167. Thereby, the MR head reads desired information from the desired track on the disc 104.

Data is amplified by the head IC 167 based on the electric resistance of the MR head device varying according to a signal magnetic field, and then supplied to the read demodulator 165 to be demodulated to an original signal. The demodulated signal is sent to the host (not shown) through the HDC 163, controller 161, and interface 162.

Further, the present invention is not limited to these preferred embodiments, and various modifications and variations may be made without departing from the spirit and scope of the present invention.

The present invention thus provides a clamp ring and a disc drive having the same, which reduces undulation when the clamp ring is attached to a hub.

What is claimed is:

1. A clamp ring that clamps a disc onto a spindle motor that rotates the disc, said clamp ring comprising an annular disc shaped body fixed onto a hub that rotates with a shaft of the spindle motor, said body arranging plural screw holes in a circumferential direction of said body, a screw that fixes said body onto the hub being inserted into each screw hole,
wherein said body arranges plural stress relaxation holes between the plural screw holes so that each stress relaxation hole and each screw hole alternate in the circumferential direction of said body, each stress relaxation hole mitigating a deformation of said body in fixing said body onto the hub with the screw, a diameter of the stress relaxation hole being equal to or greater than a diameter of the screw hole in a surface of said body from which the screw is inserted into said body.

2. A clamp ring according to claim 1, wherein the diameter of the stress relaxation hole is 1.11 times or greater as large as the diameter of the screw hole in the surface of said body.

3. A clamp ring according to claim 1, wherein the diameter of the stress relaxation hole is 1.14 times or greater as large as the diameter of the screw hole in the surface of said body.

4. A clamp ring according to claim 1, wherein said body has six screw holes and six stress relaxation holes, and the diameter of the screw hole is 3.5 mm.

5. A clam ring according to claim 1, wherein a circle that passes centers of the plural stress relaxation holes is greater than a circle that passes centers of the plural screw holes.

6. A clamp ring according to claim 1, wherein said clamp ring further includes an annular disc pressure portion that is provided onto said body and presses the disc, the stress relaxation holes being located inside the disc pressure portion.

7. A disc drive comprising a clamp ring according to claim 1.

8. A clamp ring that clamps a disc onto a spindle motor that rotates the disc, said clamp ring comprising an annular disc shaped body fixed onto a hub that rotates with a shaft of the spindle motor, said body arranging plural screw holes in a circumferential direction of said body, a screw that fixes said body onto the hub being inserted into each screw hole,
wherein said body arranges plural stress relaxation holes between the plural screw holes so that each stress relaxation hole and each screw hole alternate in the circumferential direction of said body, each stress relaxation hole mitigating a deformation of said body in fixing said body onto the hub with the screw, an area of the stress relaxation holes being equal to or greater than an area of the screw holes in a surface of said body from which the screw is inserted into said body.

9. A clamp ring according to claim 8, wherein an area of each stress relaxation hole is greater than an area of each screw hole.

10. A clamp ring according to claim 8, wherein a gross area of the stress relaxation holes is greater than a gross area of the screw holes.

11. A disc drive comprising a clamp ring according to claim 8.
